(19) United States
(12) Patent Application Publication
(10) Pub. No.: US 2006/0290733 A1
(43) Pub. Date: Dec. 28, 2006

(54) Printing method

(75) Inventor: Sung-myun Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/452,944

(22) Filed: Jun. 15, 2006

(30) Foreign Application Priority Data
Jun. 27, 2005 (KR) 2005-55846

(51) Int. Cl. B41J 2/205

(52) U.S. Cl. 347/15

(57) ABSTRACT

A printing method includes encapsulating gradation information about a gradation object for printing, transmitting the encapsulated gradation information to the rendering unit, generating a raster image by the rendering unit corresponding to the gradation object by using the encapsulated and transmitted gradation information, and performing a printing operation according to the generated raster image. Accordingly, since the rendering unit performs a rendering operation at once based on the encapsulated gradation information of the gradation object, the raster images are more rapidly generated and printed. Since it is not required to generate the tens of thousand or hundred of thousands of scan line commands to process the gradation object, memory is more effectively utilized.

### CROSS-REFERENCE TO RELATED APPLICATIONS

This application claims the benefit under 35 U.S.C. § 119(a) of Korean Patent Application No. 2005-55846, filed Jun. 27, 2005, in the Korean Intellectual Property Office, the disclosure of which is incorporated herein by reference.

### BACKGROUND OF THE INVENTION

1. Field of the Invention

Aspects of the present invention relate to a printing method, and more particularly, to a printing method which is capable of more rapidly generating and outputting a raster image with respect to a gradation-applied object.

2. Description of the Related Art

A printing system typically comprises a printing control device such as a computer and a printing device such as a printer. The printing control device sends data for printing and gives a printing command to the printing device, and the printing device performs a printing operation with respect to the data for printing received from the printing control device.

The printing process performed in a general printing system is briefly described as follows. When a printing command with respect to data for printing is input to an application of the printing control device, the data for printing generated by the application is transmitted to a printer driver. The printer driver generates print data such as vector commands, image commands and font commands with respect to respective objects constituting the printing data, and transmits the generated print data to the printing device to perform a printing operation.

Data for printing may include a gradation-applied object. FIGS. 1A to 1D are views illustrating types of gradation. FIG. 1A illustrates a gradation having a color density increasing from left to right (referred to hereinafter as a gradation having a tone level increasing from left to right), FIG. 1B illustrates a gradation having a tone level increasing from right to left, FIG. 1C illustrates a gradation having a tone level increasing from top to bottom, and FIG. 1D illustrates a gradation having a tone level increasing from bottom to top.

FIG. 2 is a block diagram illustrating a conventional printing system which processes a gradation-applied object. If a gradation-applied object (hereinafter referred to as a ‘gradation object’) is included in data for printing transmitted from an application unit 10, a command generator 20 converts the gradation object into individual scan line commands and transmits the scan line commands to a rendering unit 30. The command generator 20 divides each of lines constituting the gradation object into sections of the same tone level, and generates scan line commands with respect to the respective sections.

The rendering unit 30 generates a raster image every time it receives a scan line command from the command generator 20 and stores the raster images to a raster image buffer (not shown). A printing unit 40 prints an image corresponding to the raster images stored in the raster image butter.

Hereinafter, the conventional process of converting the gradation object into scan line commands will now be described with reference to FIG. 3. The left side of FIG. 3 shows a gradation object that has a start tone level A, an end tone level B, a width X and a height Y. The right side of FIG. 3 shows a simplified enlargement of an arbitrary line from the gradation object.

If the gradation object has a difference of 10 tone levels between the start tone level A and the end tone level B and its tone level regularly increases, the command generator 20 divides each line into 10 sections of the same tone level such as a˜b, b˜c, c˜d, . . . , i˜j, j˜k. The command generator 20 generates one scan line command with respect to each section and repeatedly performs this operation for the respective lines.

If the difference between the start tone level and the end tone level is B−A and the tone level regularly increases as shown in FIG. 3, the command generator 20 generates B−A scan line commands for each line. Accordingly, if the number of lines is Y, the total number of scan line commands for processing the gradation object is Y×(B−A).

If a gradation object has a difference of 128 tone levels between a start tone level and an end tone level and has a height of 500 lines, the total number of scan line commands generated by the command generator 20 reaches 64,000.

Since the conventional method for processing a gradation object requires converting the gradation object into scan line commands line by line, the number of scan line commands required for a printing process involving to a gradation object can be come very large. Also, since the conventional method takes up a large amount of time in comprehending the generated commands, the printing time is delayed. Also, a high capacity memory for comprehending and rendering tens of thousands or hundreds of thousands of commands is needed.

### SUMMARY OF THE INVENTION

Accordingly, an aspect of the present invention provides a printing method which is capable of more rapidly generating and printing a raster image with respect to a gradation-applied object.

Additional aspects and/or advantages of the invention will be set forth in part in the description which follows and, in part, will be obvious from the description, or may be learned by practice of the invention.

The above and/or other aspects are achieved by providing a printing method of a printing system which comprises a rendering unit to generate a raster image corresponding to data for printing. The printing method includes encapsulating gradation information about a gradation object of the data for printing, transmitting the encapsulated gradation information to the rendering unit, generating a raster image by the rendering unit corresponding to the gradation object by using the encapsulated and transmitted gradation information, and performing printing with respect to the generated raster image.

Preferably, but not necessarily, the encapsulated gradation information includes a location, a height and a width of the gradation object, a start tone level and an end tone level of each of lines constituting the gradation object, information about a direction in which the tone level increases, and a gradation equation indicating the degree of a tone level increase or decrease.

Preferably, but not necessarily, the raster image generating includes calculating scan line factors which correspond to lengths of tone levels for respective lines of the gradation object, and generating the raster images with respect to the gradation object based on the calculated scan line factors.

Preferably, but not necessarily, the scan line factors are calculated based on the width, the start tone level, the end tone level and the gradation equation of the gradation object.

Preferably, but not necessarily, if the tone level increases from left to right, generating the raster images with respect to the gradation object based on the calculated scan line factors includes setting a first variable to ‘0’; comparing the first variable with the height of the gradation object; if the first variable is less than or equal to the height of the gradation object, setting a second variable to a start tone level of a line corresponding to the first variable and setting a third variable to an end tone level of the line corresponding to the first variable; comparing the second variable with the third variable; if the second variable is less than or equal to the third variable, setting a fourth variable to ‘0’; comparing the fourth variable with a scan line factor of a tone level corresponding to the second variable of the line corresponding to the first variable; if the fourth variable is less than or equal to the scan line factor of the tone level corresponding to the second variable, generating and storing a raster image in the tone level corresponding to the second variable; and adding ‘1’ to the fourth variable and returning to comparing the fourth variable with a scan line factor of a tone level corresponding to the second variable of the line corresponding to the first variable.

Preferably, but not necessarily, generating the raster images with respect to the gradation object based on the calculated scan line factors further includes if the fourth variable is greater than the scan line factor of the tone level corresponding to the second variable as a result of comparing the fourth variable with a scan line factor of a tone level corresponding to the second variable of the line corresponding to the first variable, adding ‘1’ to the second variable and returning to comparing the second variable with the third variable, and if the second variable is greater than the third variable as a result of comparing the second variable with the third variable, adding ‘1’ to the first variable and returning to comparing the first variable with the height of the gradation object, and if the first variable is greater than the height of the gradation object as a result of comparing the first variable with the height of the gradation object, the generating of the raster image is completed and printing is performed with respect to the generated raster image.

Preferably, but not necessarily, if the tone level increases from right to left, generating the raster images with respect to the gradation object based on the calculated scan line factors includes setting a first variable to ‘0’; comparing the first variable with a height of the gradation object; if the first variable is less than or equal to the height of the gradation object, setting a second variable to a start tone level of a line corresponding to the first variable and setting a third variable to an end tone level of the line corresponding to the first variable; comparing the second variable with the third variable; if the second variable is greater than the third variable, setting a fourth variable to ‘0’; comparing the fourth variable with a scan line factor of a tone level corresponding to the second variable of the line corresponding to the first variable; if the fourth variable is less than or equal to the scan line factor of the tone level corresponding to the second variable, generating and storing a raster image in the tone level corresponding to the second variable; and adding ‘1’ to the fourth variable and returning to comparing the fourth variable with a scan line factor of a tone level corresponding to the second variable of the line corresponding to the first variable.

Preferably, but not necessarily, generating the raster images with respect to the gradation object based on the calculated scan line factors further includes if the fourth variable is greater than the scan line factor of the tone level corresponding to the second variable as a result of comparing the fourth variable with a scan line factor of a tone level corresponding to the second variable of the line corresponding to the first variable, subtracting ‘1’ from the second variable and returning to comparing the second variable with the third variable, and if the second variable is less than or equal to the third variable as a result of comparing the second variable with the third variable, adding ‘1’ to the first variable and returning to comparing the first variable with a height of the gradation object, and if the first variable is greater than the height of the gradation object as a result of comparing the first variable with a height of the gradation object, the generating of the raster image is completed and printing is performed with respect to the generated raster image.

Preferably, but not necessarily, if the tone level increases either from top to bottom or from bottom to top, generating the raster images with respect to the gradation object based on the calculated scan line factors includes setting a first variable to ‘0’ and setting a second variable to a start tone level of the gradation object, comparing the first variable with a height of the gradation object, if the first variable is less than or equal to the height of the gradation object, setting a third variable to ‘0’, comparing the third variable with a scan line factor of a tone level corresponding to the second variable, if the third variable is less than or equal to the scan line factor of the tone level corresponding to the second variable, generating and storing a raster image in the tone level corresponding to the second variable, and adding ‘1’ to the third variable and returning to comparing the third variable with a scan line factor of a tone level corresponding to the second variable.

Preferably, but not necessarily, generating the raster images with respect to the gradation object based on the calculated scan line factors further includes, if the third variable is greater than the scan line factor of the tone level corresponding to the second variable as a result of comparing the third variable with a scan line factor of a tone level corresponding to the second variable and also if the tone level increases from top to bottom, adding ‘1’ to the first and the second variables, respectively, and returning to comparing the first variable with a height of the gradation object, and if the first variable is greater than the height of the gradation object as a result of comparing the first variable with a height of the gradation object, the generating of the raster image is completed and printing is performed with respect to the generated raster image.

Preferably, but not necessarily, generating the raster images with respect to the gradation object based on the calculated scan line factors further includes, if the third variable is greater than the scan line factor of the tone level corresponding to the second variable as a result of comparing the third variable with a scan line factor of a tone level corresponding to the second variable and also if the tone level increases from the bottom to top, adding ‘1’ to the first variable and subtracting ‘1’ from the second variable, and then returning to comparing the first variable with a height of the gradation object, and if the first variable is greater than the height of the gradation object as a result of comparing the first variable with a height of the gradation object, the generating of the raster image is completed and printing is performed with respect to the generated raster image.

According to another aspect of the present invention, a computer-readable medium has computer-executable instructions to cause a printing system that comprises a rendering unit to generate a raster image corresponding to data for printing to carry out a printing method that comprises encapsulating gradation information about a gradation object of the data for printing; transmitting the encapsulated gradation information to the rendering unit; generating a raster image by the rendering unit corresponding to the gradation object by using the encapsulated and transmitted gradation information; and performing printing with respect to the generated raster image.

According to another aspect of the present invention, a printing system comprises a rendering unit that generates a raster image of a gradation object contained in data for printing based on encapsulated gradation information.

According to another aspect of the present invention, a rendering unit of a printing system is provided that generates a raster image of a gradation object contained in data for printing based on encapsulated gradation information.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A to 1D are views illustrating types of gradation;

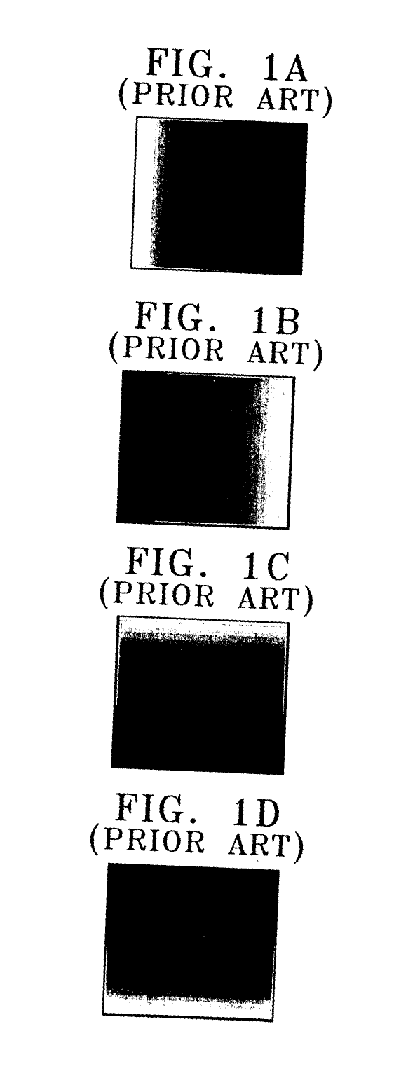

FIG. 2 is a block diagram illustrating a conventional printing system processing a gradation-applied object;

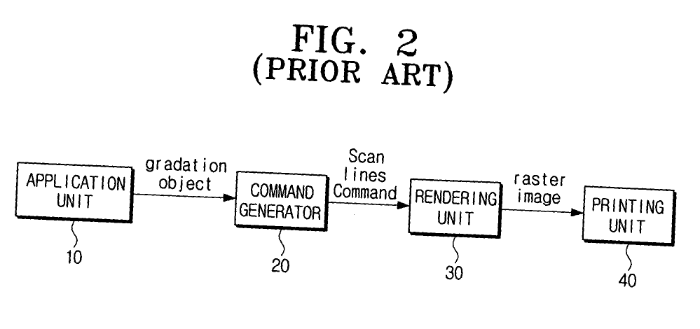

FIG. 3 is a view illustrating a conventional process of converting a gradation object into scan line commands;

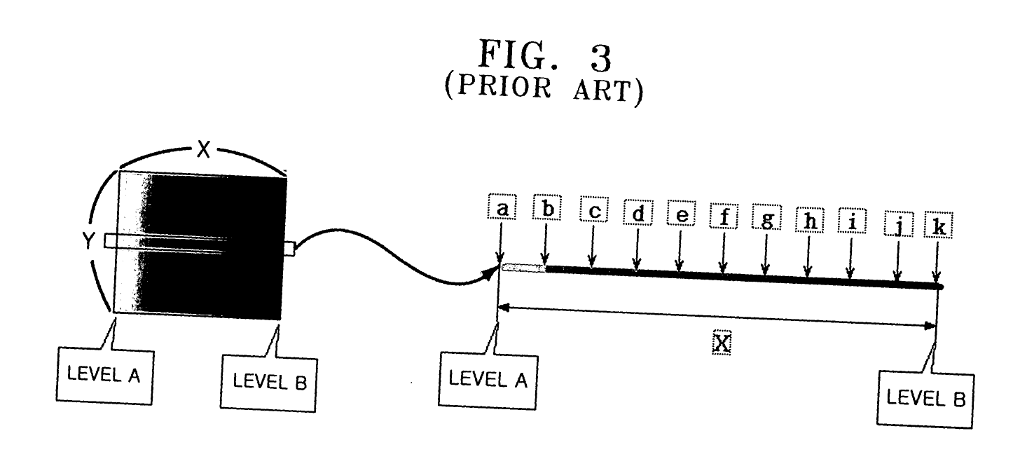

FIG. 4 is a block diagram illustrating a printing system according to an embodiment of the present invention;

FIG. 5 is a flowchart illustrating a printing method according to an embodiment of the present invention;

FIG. 6 is a flowchart illustrating the operation S500 of FIG. 5 in detail if a tone level of a gradation object increases from left to right; and

FIG. 7 is a flowchart illustrating the operation S500 of FIG. 5 in detail if a tone level of a gradation object increases from top to bottom.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

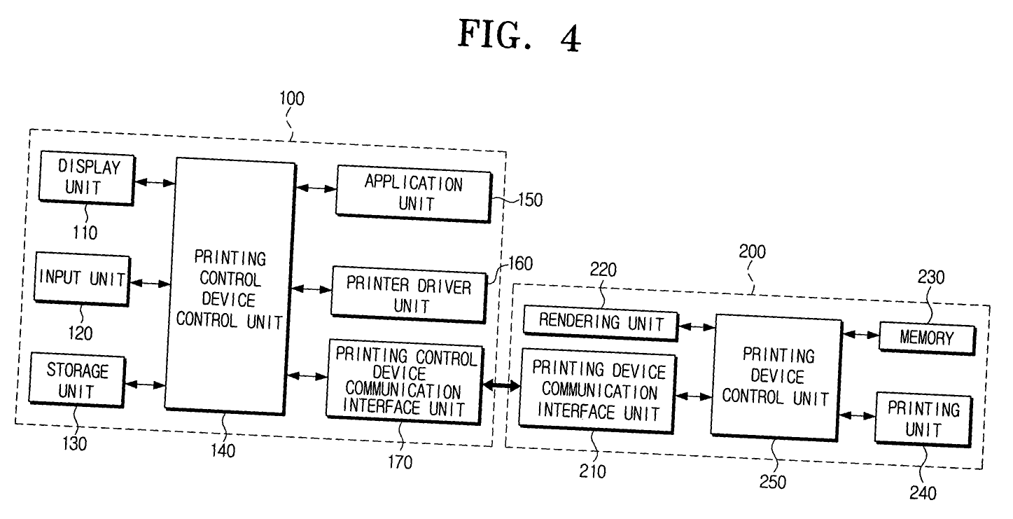

FIG. 4 is a block diagram illustrating a printing system according to an embodiment of the present invention.

Referring to FIG. 4, a printing system according to an embodiment of the present invention comprises a printing control device 100 and a printing device 200. The printing control device 100 comprises a display unit 110, an input unit 120, a storage unit 130, a printing control device control unit 140, an application unit 150, a printer driver unit 160 and a printing control device communication interface unit 170. The printing device 200 comprises a printing device communication interface unit 210, a rendering unit 220, a memory 230, a printing unit 240, and a printing device control unit 250.

The display unit 110 displays information of various sorts provided from the printing control device 100 and is typically a monitor such as, for example, a cathode ray tube (CRT) monitor or a liquid crystal display (LCD) monitor.

The input unit 120 has a plurality of function keys to set or select functions supported by the printing control device 100, and, as a non-limiting example, may be a keyboard or a mouse.

The storage unit 130 stores data written for printing by various programs and the application unit 150 which are required to realize the functions of the printing control device 100.

The application unit 150 may comprise an application program such as, for example, a word processor program, a database program, an image edit program or a browser. Any program can embody the application unit 150 if it can input a printing command with respect to data for printing. The application unit 150 transmits data for printing to the printer driver unit 160 through a graphics device interface (not shown) on receipt of a printing command. The printer driver unit 160 processes the data for printing object by object.

The printing control device control unit 140 controls overall operations of the respective elements of the printing control device 100. When a printing command is input to the application unit 140, the printing control device control unit 140 instructs the printer driver 160 to convert corresponding data for printing to print data that is comprehensible by the printing device 200 and to transmit the print data to the printing device 200 through the printing control device communication interface unit 170.

If a gradation-applied object (referred to hereinbelow as a ‘gradation object’) is included in the data for printing, the printer driver unit 160 obtains gradation information about the gradation object, encapsulates the gradation information and transmits the encapsulated gradation information to the rendering unit 220. The gradation information includes the location, height and width of the gradation object, a start tone level and an end tone level of each of lines constituting the gradation object, direction information of the gradation (e.g., a direction in which the tone level increases or decreases), an equation indicating a degree of the tone level increase or decrease (referred to hereinbelow as a ‘gradation equation’). Although in the embodiment of FIG. 4 the rendering unit 220 is shown as installed in the printing device 200, it can also be installed in the printing control device 100. For example, the rendering unit 220 may be included in the printer driver unit 160.

The printing control device communication interface unit 170 may comprise a parallel port, a USB port, a wireless module or any other type of interface in order for the printing control device 100 to communicate with an external device. According to the embodiment of FIG. 4, the printing control device communication interface unit 170 is connected with the printing device 200 and serves as a bridge to exchange printing data information with the printing device 200. Upon receiving the encapsulated gradation information from the printer driver unit 160, the printing control device communication interface unit 170 transmits it to the rendering unit 220 through the printing device communication interface unit 210.

The printing device communication interface unit 210 may comprise a parallel port, a USB port, a wireless module or any other type of interface in order for the printing device 200 to communicate with an external device. According to the embodiment of FIG. 4, the printing device communication interface unit 210 communicates with the printing control device 100 through the printing control device communication interface unit 170 and transmits the encapsulated gradation information received from the printing control device 100 to the rendering unit 220.

The rendering unit 220 generates a raster image by performing a rendering with respect to the print data received from the printing control device 100 and stores the raster image in the memory 230. More specifically, the rendering unit 220 generates a raster image corresponding to the gradation object in a predetermined manner based on the encapsulated gradation information received from the printer driver unit 160, and stores the raster image in the memory 230. The method of generating a raster image based on gradation information will be described in detail below.

The memory 230 stores the raster image generated by the rendering unit 220 and provides the raster image to the printing unit 240 under the control of the printing device control unit 250.

The printing unit 240 performs a printing operation with respect to the raster image generated by the rendering unit 220 under the control of the printing device control unit 250.

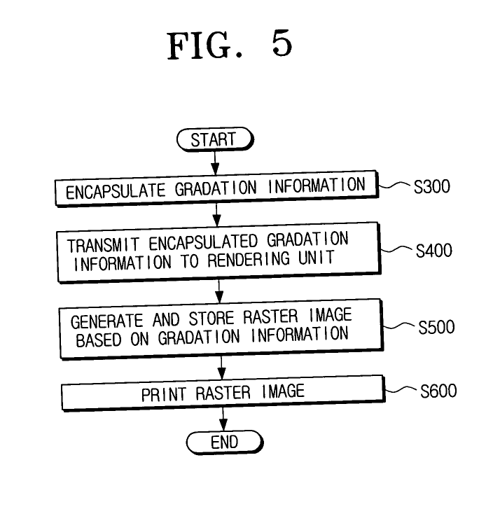

FIG. 5 is a flowchart illustrating a printing method according to an embodiment of the present invention.

Referring to FIG. 5, if a gradation object is included in data for printing, the printer driver unit 160 obtains gradation information and encapsulates the gradation information at operation S300. The gradation information includes the location, height and width of the gradation object, a start tone level and an end tone level of each of lines constituting the gradation object, information about a direction in which the tone level increases or decreases, and an equation indicating the degree of the tone level increase or decrease.

Next, the printer driver unit 160 transmits the encapsulated gradation information to the rendering unit 220 at operation S400. The rendering unit 220 generates a raster image based on the gradation information and stores the raster image to the memory 230 at operation S500. The printing unit 240 prints an image corresponding to the raster image generated by the rendering unit 220 on a printing medium at operation S600.

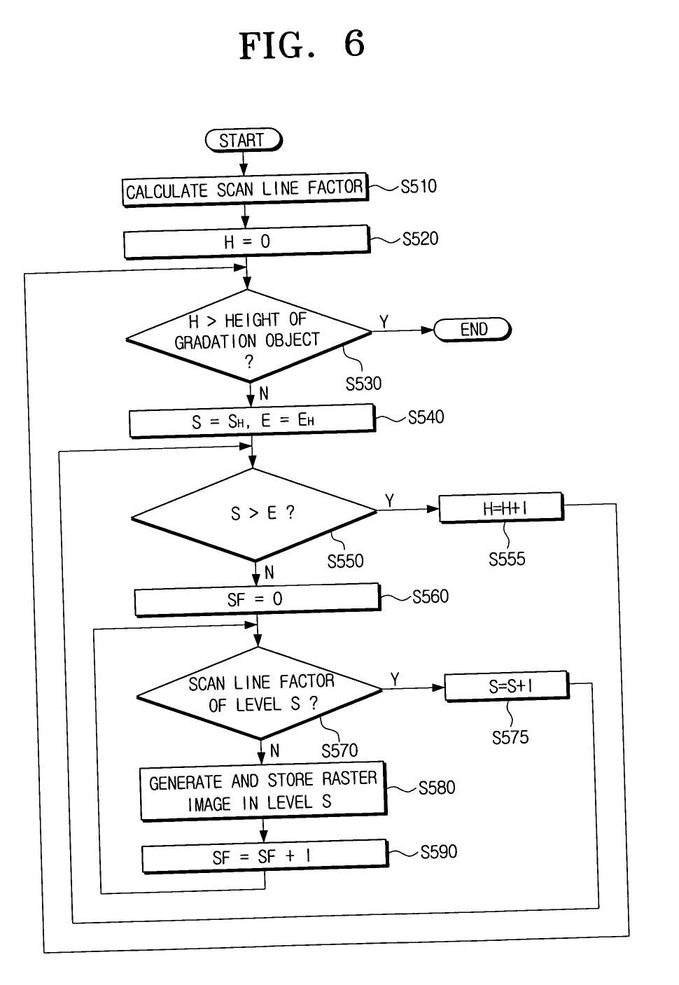

With reference to FIG. 6, the operation S500 of FIG. 5 will now be described in detail. FIG. 6 illustrates the operation S500 of FIG. 5 if a tone level of the gradation object increases from left to right.

Referring to FIG. 6, at operation S510, the rendering unit 220 obtains a scan line factor for each tone level based on the width, the start tone level, the end tone level, the direction information of the tone level and the gradation equation of the gradation object. The scan line factor is a value that corresponds to the length of each section and is obtained as a result of dividing one line of the gradation object into several sections of the same tone level. For example, if the tone level increases in a horizontal direction and the gradation equation is a first function, a value obtained by dividing the width of the gradation object by a difference between the start tone level and the end tone level is a scan line factor for each tone level. On the other hand, if the tone level increases in a vertical direction, the width of the gradation object itself is the scan line factor for each tone level.

Next, the rendering unit 220 sets a first variable ‘H’ to ‘0’ at operation S520 and compares the first variable ‘H’ with the height of the gradation object at operation S530. If the first variable ‘H’ is greater than the height of the gradation object at operation S530, the generating of the raster image is completed, and otherwise, the rendering unit 220 performs the operation S540.

At the operation S540, the rendering unit 220 sets a second variable ‘S’ to a start tone level S_{H} of a line corresponding to the first variable ‘H’ and sets a third variable ‘E’ to an end tone level E_{H} corresponding to the first variable ‘H’. The rendering unit 220 compares the second variable ‘S’ with the third variable ‘E’ at operation S550. If the second variable ‘S’ is greater than the third variable ‘E’, the rendering unit 220 performs the operation S555 to add ‘1’ to the first variable ‘H’ and returns to the operation S530. Otherwise, the rendering unit 220 performs the operation S560 to set a fourth variable ‘SF’ to ‘0’.

The rendering unit 220 compares the fourth variable ‘SF’ with a scan line factor of the tone level ‘S’ at operation S570. If the fourth variable ‘SF’ is greater than the scan line factor of the tone level ‘S’, the rendering unit 220 performs operation S575 to add ‘1’ to the second variable ‘S’ and returns to the operation S550.

At the operation S570, if the fourth variable ‘SF’ is less than or equal to the scan line and stores the raster image to the memory 230 at operation S580, and adds ‘1’ to the fourth variable ‘SF’ at operation S590 and returns to the operation S570.

The rendering unit 220 repeatedly performs the operations S530 to S590 until the first variable ‘H’ exceeds the height of the gradation object and thereby generates the raster image corresponding to the gradation object.

On the other hand, if the tone level increases from right to left, a raster image is generated in the following process: if the second variable ‘S’ is less than the third variable ‘E’ at the operation S550, the operation S555 is performed, and otherwise, the operation S560 is performed, and ‘1’ is subtracted from the second variable ‘S’ at operation S575.

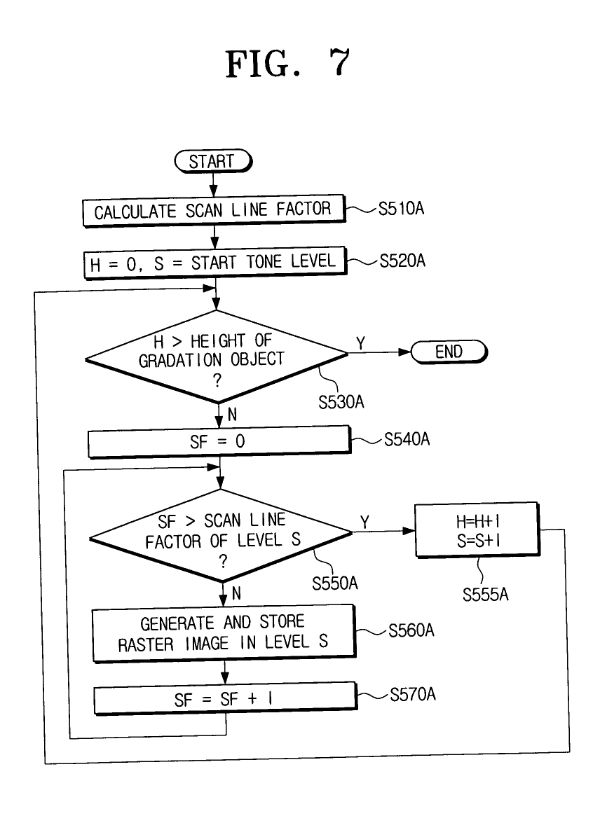

FIG. 7 is a flowchart illustrating the operation S500 of FIG. 5 if the tone level of the gradation object increases from top to bottom.

Referring to FIG. 7, the rendering unit 220 obtains a scan line factor for each tone level based on the width, the start tone level, the end tone level, the direction information and the gradation equation of the gradation object at operation S510a.

The rendering unit 220 sets a first variable ‘H’ to ‘0’, and sets a second variable ‘S’ to a start tone level of the gradation object at operation S520a.

Next, the rendering unit 220 compares the first variable ‘H’ with the height of the gradation object at operation S530a. If the first variable ‘H’ is greater than the height of the gradation objection at the operation S530a, the generating of the raster image is completed, and otherwise, the rendering unit 220 performs the operation S540a.

If the first variable ′H′ is less than or equal to the height of the gradation object, the rendering unit 220 sets a third variable ‘SF’ to ‘0’ at operation S540a and then performs the operation S550a.

At the operation S550a, the rendering unit 220 compares the third variable ‘SF’ with a scan line factor of the tone level ‘S’. If the third variable ‘SF’ is greater than the scan line factor of the tone level ‘S’, the rendering unit 220 performs operation S555a to add ‘1’ to the first variable ‘H’,and the second variable ′S′, respectively, and returns to the operation S530a.

If the third variable ‘SF’ is less than or equal to the scan line factor of the tone level ‘S’ at the operation S550a, the rendering unit 220 generates a raster image in the tone level ‘S’ and stores it to the memory 230 at operation S560a, and adds ‘1’ to the third variable ‘SF’ at operation 570a and returns to the operation S550a.

The rendering unit 220 repeatedly performs the operations S530a to S570a until the first variable ‘H’ exceeds the height of the gradation object and thereby generates the raster images corresponding to the gradation object.

On the other hand, if the tone lever increases from the bottom to top, a raster image is generated by subtracting ‘1’ from the second variable ‘S’ at the operation S555a.

According to the printing method as described above, since the rendering unit 220 performs the rendering operation at once based on the encapsulated gradation information of the gradation object, the raster images are more rapidly generated and printed than in the conventional rendering process performed with respect to tens of thousands or hundreds of thousands of scan line commands.

Since it is not required to generate the tens of thousand or hundred of thousands of scan line commands to process the gradation object, the memory 230 is more effectively utilized.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A printing method of a printing system which comprises a rendering unit to generate a raster image corresponding to data for printing, the method comprising:
encapsulating gradation information about a gradation object of the data for printing;
transmitting the encapsulated gradation information to the rendering unit;
generating a raster image by the rendering unit corresponding to the gradation object by using the encapsulated and transmitted gradation information; and
performing printing with respect to the generated raster image.

2. The printing method as claimed in claim 1, wherein the encapsulated gradation information includes a location, a height and a width of the gradation object, a start tone level and an end tone level of each line constituting the gradation object, information about a direction in which a tone level increases, and a gradation equation indicating a degree of a tone level increase or decrease.

3. The printing method as claimed in claim 2, wherein the raster image generating comprises:
calculating scan line factors which correspond to lengths of tone levels for respective lines of the gradation object; and
generating the raster image with respect to the gradation object based on the calculated scan line factors.

4. The printing method as claimed in claim 3, wherein the scan line factors are calculated based on the width, the start tone level, the end tone level and the gradation equation of the gradation object.

5. The printing method as claimed in claim 4, wherein if the tone level increases from left to right, generating the raster image with respect to the gradation object based on the calculated scan line factors comprises:
setting a first variable to ‘0’;
comparing the first variable with the height of the gradation object;
if the first variable is less than or equal to the height of the gradation object, setting a second variable to a start tone level of a line corresponding to the first variable and setting a third variable to an end tone level of the line corresponding to the first variable;
comparing the second variable with the third variable;
if the second variable is less than or equal to the third variable, setting a fourth variable to ‘0’;
comparing the fourth variable with a scan line factor of a tone level corresponding to the second variable of the line corresponding to the first variable;
if the fourth variable is less than or equal to the scan line factor of the tone level corresponding to the second variable, generating and storing a raster image in the tone level corresponding to the second variable; and
adding ‘1’ to the fourth variable and returning to comparing the fourth variable with the scan line factor of the tone level corresponding to the second variable of the line corresponding to the first variable.

6. The printing method as claimed in claim 5, wherein generating the raster image with respect to the gradation object based on the calculated scan line factors further comprises:
if the fourth variable is greater than the scan line factor of the tone level corresponding to the second variable as a result of comparing the fourth variable with the scan line factor of the tone level corresponding to the second variable of the line corresponding to the first variable, adding ‘1’ to the second variable and returning to comparing the second variable with the third variable; and
if the second variable is greater than the third variable as a result of comparing the second variable with the third variable, adding ‘1’ to the first variable and returning to comparing the first variable with the height of the gradation object, and
wherein if the first variable is greater than the height of the gradation object as a result of comparing the first variable with the height of the gradation object, the generating of the raster image is completed and printing is performed with respect to the generated raster image.

7. The printing method as claimed in claim 4, wherein, if the tone level increases from right to left, generating the raster image with respect to the gradation object based on the calculated scan line factors comprises:
setting a first variable to ‘0’;
comparing the first variable with a height of the gradation object;
if the first variable is less than or equal to the height of the gradation object, setting a second variable to a start tone level of a line corresponding to the first variable and setting a third variable to an end tone level of the line corresponding to the first variable;
comparing the second variable with the third variable;
if the second variable is greater than the third variable, setting a fourth variable to ‘0’;
comparing the fourth variable with a scan line factor of a tone level corresponding to the second variable of the line corresponding to the first variable;
if the fourth variable is less than or equal to the scan line factor of the tone level corresponding to the second variable, generating and storing a raster image in the tone level corresponding to the second variable; and
adding ‘1’ to the fourth variable and returning to comparing the fourth variable with the scan line factor of the tone level corresponding to the second variable of the line corresponding to the first variable.

8. The printing method as claimed in claim 7, wherein generating the raster image with respect to the gradation object based on the calculated scan line factors further comprises:
if the fourth variable is greater than the scan line factor of the tone level corresponding to the second variable as a result of comparing the fourth variable with the scan line factor of the tone level corresponding to the second variable of the line corresponding to the first variable, subtracting ‘1’ from the second variable and returning to comparing the second variable with the third variable; and
if the second variable is less than or equal to the third variable as a result of comparing the second variable with the third variable, adding ‘1’ to the first variable and returning to comparing the first variable with the height of the gradation object, and
wherein if the first variable is greater than the height of the gradation object as a result of comparing the first variable with the height of the gradation object, the generating of the raster image is completed and printing is performed with respect to the generated raster image.

9. The printing method as claimed in claim 4, wherein, if the tone level increases either from top to bottom or from bottom to top, generating the raster image with respect to the gradation object based on the calculated scan line factors comprises:
setting a first variable to ‘0’ and setting a second variable to a start tone level of the gradation object;
comparing the first variable with a height of the gradation object;
if the first variable is less than or equal to the height of the gradation object, setting a third variable to ‘0’;
comparing the third variable with a scan line factor of a tone level corresponding to the second variable;
if the third variable is less than or equal to the scan line factor of the tone level corresponding to the second variable, generating and storing a raster image in the tone level corresponding to the second variable; and
adding ‘1’ to the third variable and returning to comparing the third variable with the scan line factor of the tone level corresponding to the second variable.

10. The printing method as claimed in claim 9, wherein generating the raster image with respect to the gradation object based on the calculated scan line factors further comprises:
if the third variable is greater than the scan line factor of the tone level corresponding to the second variable as a result of comparing the third variable with the scan line factor of the tone level corresponding to the second variable and also if the tone level increases from top to bottom, adding ‘1’ to the first and the second variables, respectively, and returning to comparing the first variable with the height of the gradation object, and
wherein, if the first variable is greater than the height of the gradation object as a result of comparing the first variable with the height of the gradation object, the generating of the raster image is completed and printing is performed with respect to the generated raster image.

11. The printing method as claimed in claim 9, wherein generating the raster image with respect to the gradation object based on the calculated scan line factors further comprises:
if the third variable is greater than the scan line factor of the tone level corresponding to the second variable as a result of comparing the third variable with the scan line factor of the tone level corresponding to the second variable and also if the tone level increases from the bottom to top, adding ‘1’ to the first variable and subtracting ‘1’ from the second variable, and then returning to comparing the first variable with the height of the gradation object, and
wherein, if the first variable is greater than the height of the gradation object as a result of comparing the first variable with the height of the gradation object, the generating of the raster image is completed and printing is performed with respect to the generated raster image.

12. A computer-readable medium having computer-executable instructions to cause a printing system that comprises a rendering unit to generate a raster image corresponding to data for printing to carry out a printing method that comprises:
encapsulating gradation information about a gradation object of the data for printing;
transmitting the encapsulated gradation information to the rendering unit;
generating a raster image by the rendering unit corresponding to the gradation object by using the encapsulated and transmitted gradation information; and
performing printing with respect to the generated raster image.

13. A printing system comprising a rendering unit that generates a raster image of a gradation object contained in data for printing based on encapsulated gradation information.

14. The printing system of claim 13, wherein the encapsulated gradation information includes a location, a height and a width of the gradation object, a start tone level and an end tone level of each line constituting the gradation object, information about a direction in which a tone level increases, and a gradation equation indicating a degree of a tone level increase or decrease.

15. The printing system of claim 14, wherein the rendering unit calculates scan line factors that correspond to lengths of tone levels for respective lines of the gradation object and generates the raster image with respect to the gradation object based on the calculated scan line factors.

16. The printing system as claimed in claim 15, wherein the scan line factors are calculated based on the width, the start tone level, the end tone level and the gradation equation of the gradation object.

17. A rendering unit of a printing system, wherein the rendering unit generates a raster image of a gradation object contained in data for printing based on encapsulated gradation information.

18. The rendering unit of claim 17, wherein the rendering unit calculates scan line factors that correspond to lengths of tone levels for respective lines of the gradation object and generates the raster image with respect to the gradation object based on the calculated scan line factors.

19. The rendering unit as claimed in claim 18, wherein the scan line factors are calculated based on the width, the start tone level, the end tone level and the gradation equation of the gradation object.

20. The rendering unit as claimed in claim 19, wherein the scan line factors are calculated based on the width, the start tone level, the end tone level and the gradation equation of the gradation object.
